(19) United States
(12) Patent Application Publication
(10) Pub. No.: US 2025/0385333 A1
(43) Pub. Date: Dec. 18, 2025

(54) BATTERY MODULE

(71) Applicants: HYUNDAI MOTOR COMPANY, Seoul (KR); KIA CORPORATION, Seoul (KR)

(72) Inventors: Gyung Hoon Shin, Hwaseong-si (KR); Hae Woong Jung, Hwaseong-si (KR)

(73) Assignees: HYUNDAI MOTOR COMPANY, Seoul (KR); KIA CORPORATION, Seoul (KR)

(21) Appl. No.: 19/187,275

(22) Filed: Apr. 23, 2025

(30) Foreign Application Priority Data
Jun. 12, 2024 (KR) 10-2024-0076566
Feb. 11, 2025 (KR) 10-2025-0017454

(51) Int. Cl. H01M 10/613; H01M 10/647; H01M 10/6551; H01M 50/211; H01M 50/289; H01M 50/342; H01M 50/503; H01M 50/591

(52) U.S. Cl. CPC H01M 10/613; H01M 10/647; H01M 10/6551; H01M 50/211; H01M 50/289; H01M 50/3425; H01M 50/503; H01M 50/591

(57) ABSTRACT

Disclosed is a battery module including a battery stack including a plurality of battery cells stacked. The battery module further includes a pad member, a holder member provided at a side of the battery stack, a busbar assembled to the holder member and electrically connected to the battery stack, and a first conductive sheet provided to face the busbar and containing a thermally conductive material. The plurality of battery cells each have a lead region tightly attached to the busbar. The first conductive sheet is provided to face the busbar with the lead region interposed therebetween, and the first conductive sheet is tightly attached to the lead region or the busbar.

### CROSS-REFERENCE TO RELATED APPLICATIONS

This application claims priority to and the benefit of Korean Patent Application No. 10-2024-0076566 filed in the Korean Intellectual Property Office on Jun. 12, 2024, and Korean Patent Application No. 10-2025-0017454 filed in the Korean Intellectual Property Office on Feb. 11, 2025, the entire contents of which are incorporated herein by reference.

### TECHNICAL FIELD

The present disclosure relates to a battery module, and more particularly, to a battery module including a pouch-type battery cell.

### BACKGROUND

In order to satisfy the marketability of battery modules mounted in electric vehicles, the battery modules should charge sufficiently with electrical energy in a short (e.g., reduced) amount of time. Further, it is useful for the battery to have a temperature within an appropriate range during an operating process of the battery module. To this end, it may be useful to provide a heat dissipation structure capable of (e.g., effectively) dissipating heat, which is generated in the battery module, to the outside.

As the market for high-performance electric vehicles expands, maximizing the performance of the battery pack by improving methods of stacking the battery modules may be considered. In the case of high-performance battery packs, the amount of heat generated in the battery pack may increase. Thus, the amount of heat generated in the high-performance battery pack may also be considered, as it may be challenging to (e.g., effectively) dissipate heat generated in the high-performance battery pack. For example, a large amount of heat may be generated from an electrode lead provided in a battery cell in the high-performance battery module and thus it may be challenging to (e.g., effectively) dissipate heat generated from the electrode lead, and the electrode lead is easily degraded.

### SUMMARY

The present disclosure provides an improved way to dissipate heat generated in a battery module.

In particular, the present disclosure has been made to more effectively dissipate heat generated from an electrode lead in a battery module.

One aspect of the present disclosure provides a battery module including a battery stack including a plurality of battery cells stacked in a first direction D1, and one or more pad members provided between the plurality of battery cells, a holder member provided at one side of the battery stack in a second direction D2 intersecting the first direction D1, a busbar assembled to the holder member and electrically connected to the battery stack, and a first conductive sheet provided to face the busbar and may contain a thermally conductive material, in which the plurality of battery cells each have a lead region protruding outward and (e.g., tightly) coupled (e.g., attached) to the busbar, and in which the first conductive sheet is provided to face the busbar with the lead region interposed therebetween, and the first conductive sheet is (e.g., tightly) attached to the lead region or the busbar.

An outer surface of the busbar in the second direction D2 may be provided on an (e.g., one) imaginary plane P formed in a direction intersecting the second direction D2.

The first conductive sheet may be configured to cover an (e.g., entire) region in which the lead region is (e.g., tightly) attached to the busbar.

The battery module may further include an end cap spacing member provided outward of the busbar in the second direction D2 and having a through-hole configured to accommodate the first conductive sheet, and an end cap member provided to face the busbar with the end cap spacing member interposed therebetween. The end cap member may be (e.g., tightly) attached to the first conductive sheet.

The end cap member may include a cap body configured to provide (e.g., define) a body of the end cap member and may contain an electrically conductive material. The end cap member may include an insulation sheet provided between the cap body and the first conductive sheet, wherein the insulation sheet may be (e.g., tightly) attached to the first conductive sheet, the cap body, and the end cap spacing member, and the insulation sheet may contain an electrically non-conductive material.

The battery module may further include a second conductive sheet (e.g., tightly) attached to one side surface of the cap body and may contain a thermally conductive material.

The second conductive sheet may be (e.g., tightly) attached to one side surface of the cap body in a third direction D3 intersecting the first and second directions D1 and D2.

An (e.g., entire) outer surface of the first conductive sheet in the second direction D2 may be (e.g., tightly) attached to the insulation sheet.

An (e.g., entire) outer periphery of the first conductive sheet may be spaced apart inward from an (e.g., entire) outer periphery of the insulation sheet.

The end cap spacing member may include a cap spacing body configured to provide (e.g., define) a body of the end cap spacing member and having the through-hole, and a cap spacing interference region protruding from the cap spacing body. The cap spacing interference region may be provided to face the busbar.

The cap spacing interference region may protrude from the cap spacing body toward the busbar.

The cap spacing interference region may be provided in a peripheral region that provides (e.g., defines) the through-hole.

The cap spacing interference region may protrude from the cap spacing body in a third direction D3. The third direction D3 intersects the first and second directions D1 and D2. A length of the cap spacing interference region in the third direction D3 may be (e.g., substantially) equal to or larger than a thickness of the first conductive sheet in the third direction D3.

The end cap spacing member may include a cap spacing body configured to provide (e.g., define) a body of the end cap spacing member and having a discharge hole spaced apart from the first conductive sheet, a cover region accommodated in the discharge hole, and a fracture region configured to connect the cap spacing body and the cover region, and i) a thickness of the fracture region may be smaller than a thickness of the cap spacing body and a thickness of the cover region in a region connected to the fracture region, or ii) the fracture region may be provided (e.g., only) at a part of a periphery of the cover region.

The end cap spacing member may include a cap spacing body configured to provide (e.g., define) a body of the end cap spacing member, and a cap spacing protrusion region provided on an outer surface of the cap spacing body in the second direction D2 and protruding outward, a busbar accommodation hole, which has a hole shape and accommodates a partial region of the busbar, may be formed in a region of the cap spacing body in which the cap spacing protrusion region is provided, and the cap spacing protrusion region may have an assembling hole. The battery module may further include a busbar protection cap member configured to cover the busbar from the outside and may have a partial region (e.g., accommodated) in the assembling hole.

The battery module may further include an outer busbar provided to be in contact with the busbar, in which the outer busbar is inserted into the busbar protection cap member while penetrating the busbar protection cap member and provided to be in contact with the busbar. The end cap spacing member may further include a contact prevention region protruding toward the outer busbar and may be provided to face a region of the cap spacing body in which the outer busbar penetrates the busbar protection cap member.

The battery module may further include a heat transfer member provided at one side of the battery stack and provided to be in contact with the battery stack, in which the plurality of battery cells extend in the second direction D2, in which the heat transfer member is provided at one side of the battery stack in a third direction D3 intersecting the first and second directions D1 and D2, and in which the heat transfer member includes first and second heat transfer members made of different materials.

The first heat transfer member and the second heat transfer member may each contain a curable material. Fluidity of the first heat transfer member measured before the first heat transfer member is cured may be lower than fluidity of the second heat transfer member measured before the second heat transfer member is cured.

The first heat transfer member may be applied to a peripheral region at one side of the second heat transfer member in the second direction D2.

Each of the plurality of battery cells may include a pouch-type exterior material having an internal space, and an electrode stack accommodated in the internal space. The pouch-type exterior material may include a pouch body region configured to provide (e.g., define) the internal space, and a sealing region formed by attaching partial regions of the pouch-type exterior material and the sealing region is provided to surround a periphery of the pouch body region, the sealing region may include a first sealing region formed at one side of the pouch-type exterior material in the third direction D3, and the first sealing region may be provided to be in contact with the heat transfer member.

According to the present disclosure, the embodiments provided in the present disclosure (e.g., more effectively) dissipates heat generated in the battery module.

Further, according to the present disclosure, it is possible to (e.g., more effectively) dissipate heat generated from the electrode lead in the battery module.

### BRIEF DESCRIPTION OF THE DRAWINGS

FIG. 1 is a perspective view of a battery module according to the present disclosure.

FIG. 2 is an exploded perspective view illustrating components provided at one side of a battery stack in a second direction in the battery module according to the present disclosure.

FIG. 3 is a cross-sectional view illustrating a state in which one side portion of the battery module in the second direction according to the present disclosure is cut in a direction perpendicular to a third direction.

FIG. 4 is a cross-sectional view illustrating a state in which one side portion of the battery module in the second direction according to the present disclosure is cut in a direction perpendicular to a first direction.

FIG. 5 is a perspective view illustrating a state in which an end cap member, an end cap spacing member, and a first conductive sheet provided in the battery module according to the present disclosure are assembled.

FIG. 6 is an exploded perspective view of FIG. 5.

FIG. 7 is a perspective view of the end cap spacing member provided in the battery module according to the present disclosure.

FIG. 8 is an enlarged view illustrating one side of the battery module in the second direction according to the present disclosure.

FIG. 9 is an enlarged view illustrating a state in which an outer busbar is assembled to the battery module according to the present disclosure.

FIG. 10 is a view illustrating a cut surface taken along line A-A in FIG. 9.

FIG. 11 is a view illustrating a cut surface taken along line B-B in FIG. 9.

FIG. 12 is a cross-sectional view illustrating a state in which the battery module according to the present disclosure is cut in the direction perpendicular to the first direction.

FIG. 13 is a side view of a battery cell provided in the battery module according to the present disclosure.

### DETAILED DESCRIPTION

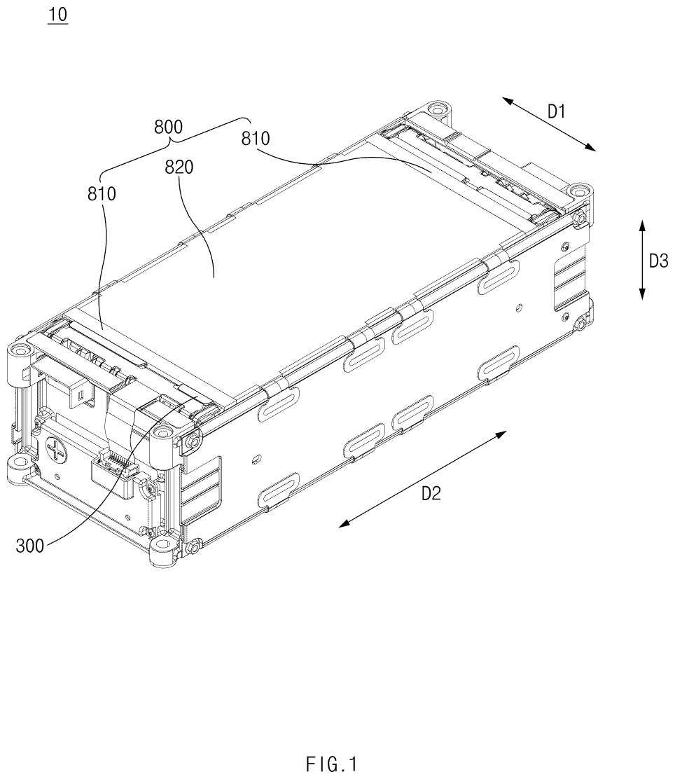

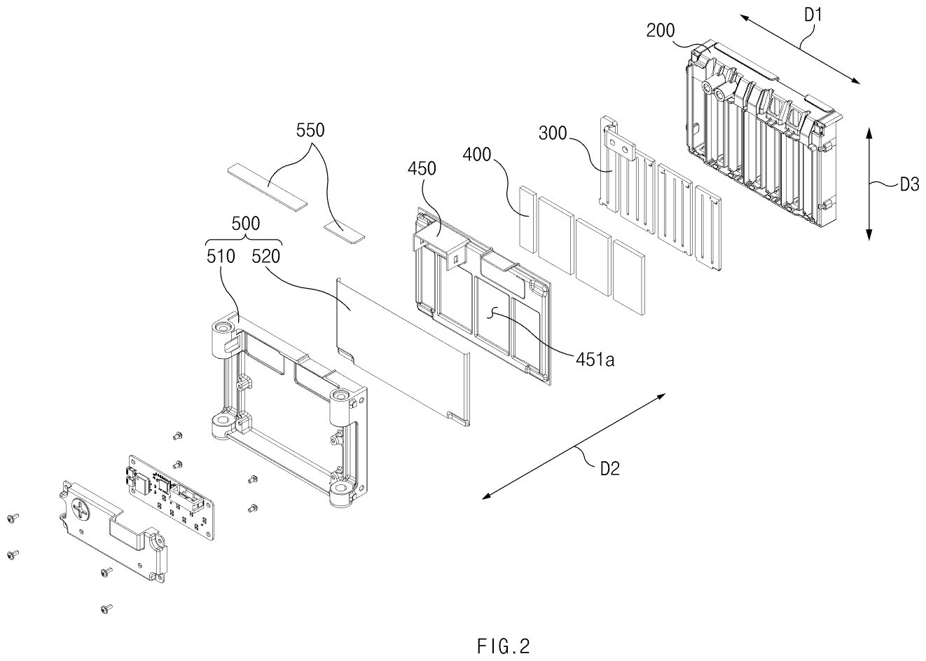

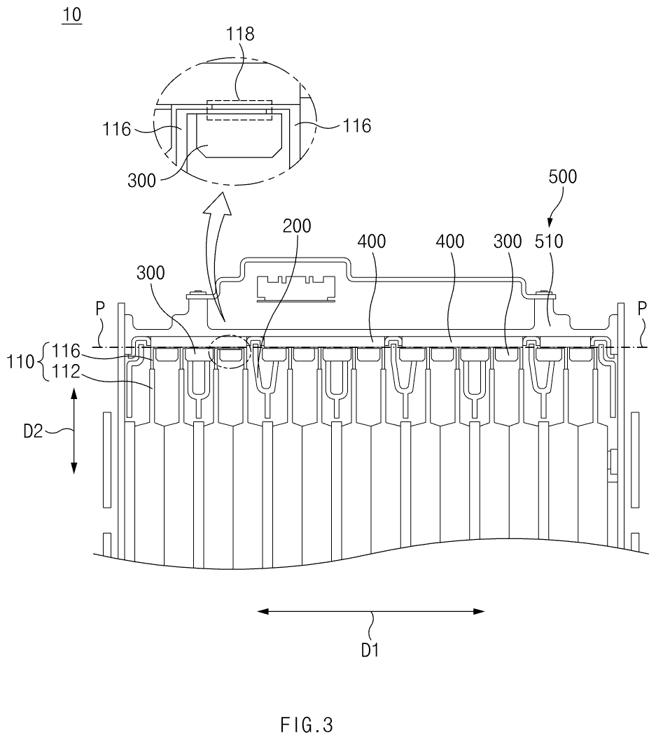

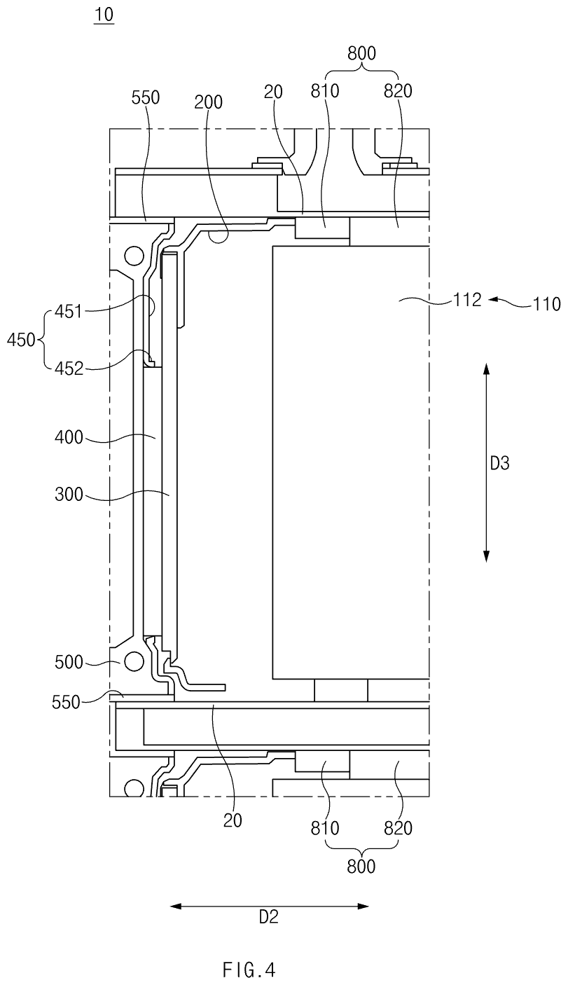

FIG. 1 is a perspective view of a battery module according to the present disclosure, and FIG. 2 is an exploded perspective view illustrating components provided at one side of a battery stack in a second direction in the battery module according to the present disclosure. FIG. 3 is a cross-sectional view illustrating a state in which one side portion of the battery module in the second direction according to the present disclosure is cut in a direction perpendicular to a third direction, and FIG. 4 is a cross-sectional view illustrating a state in which one side portion of the battery module in the second direction according to the present disclosure is cut in a direction perpendicular to a first direction.

With reference to FIGS. 1 to 4, a battery module 10 according to the present disclosure may include a battery stack 100 including a plurality of battery cells 110 stacked in a first direction D1, and one or more pad members 120 provided between the plurality of battery cells 110. As described below, the battery cell 110 may be a pouch-type secondary battery. In addition, for example, the battery stack 100 may have a structure in which the two battery cells 110 and one pad member 120 are alternately stacked. The pad member 120 may be configured to press the battery cells 110 so that predetermined surface pressure is applied to the battery cells 110 in the battery stack 100.

In addition, the battery module 10 may further include a holder member 200 provided at one side of the battery stack 100 in a second direction D2 intersecting the first direction D1, and busbars 300 assembled to the holder member 200 and electrically connected to the battery stack 100. The second direction D2 may perpendicularly intersect the first direction D1. The busbar 300 may be configured to mediate the electrical connection between the battery module 10 and external components.

The plurality of battery cells 110 may have lead regions 116 protruding outward, (e.g., tightly) attached to the busbars 300, and electrically connected to the busbars 300. For example, as illustrated in FIG. 3, the lead region 116 may include a first section configured to penetrate the busbar 300 and protruding in the second direction D2, and a second section bent in the first direction D1 from the first section and (e.g., tightly) attached to an outer surface of the busbar 300 in the second direction D2. For example, the battery cell 110 may extend in the second direction D2 as the longitudinal direction, and the lead region 116 may be provided at an end of each of the plurality of battery cells 110 in the second direction D2. For example, the busbar 300 and the lead region 116 may be fixed to each other by welding.

As illustrated in FIG. 3, when the lead region 116 is viewed from a location spaced apart from the lead region 116 in the second direction D2, there may be overlap regions 118 in which at least some of the lead regions 116 of the plurality of battery cells 110 are provided to overlap one another. The overlap region 118 may be (e.g., tightly) attached to the busbars 300. For example, the overlap region 118 may be welded to the busbar 300. Therefore, in the regions in which the overlap regions 118 are fixed to the busbars 300, some of the plurality of lead regions 116, which provide (e.g., define) the overlap regions 118, may be (e.g., tightly) attached directly to the busbars 300, and some of the other lead regions 116, which provide (e.g., define) the overlap regions 118, may be provided to face the busbars 300 with the lead regions 116, which are (e.g., tightly) attached directly to the busbars 300, interposed therebetween. For example, the above-mentioned overlap region 118 may be formed only at one position at one side of the battery module 10 in the second direction D2. Because one of the two lead regions 116, which provide (e.g., define) the overlap region 118, is provided to face the busbar 300 with the other lead region 116 interposed therebetween, one lead region 116 may not be technically considered as being (e.g., tightly) attached to the busbar 300. In the present specification, both the two lead regions 116, which provide (e.g., define) the overlap region 118, are provided (e.g., defined) as being (e.g., tightly) attached to the busbar 300.

As described above, according to the present disclosure, some of the plurality of lead regions 116 may be electrically connected to the busbars 300 through the overlap regions 118, such that the busbar 300 may have a flat shape as a whole without having a bent shape. That is, a width of the battery stack 100 in the first direction D1 and a width of the busbar 300 in the first direction D1 may correspond to each other. In this case, according to the present disclosure, some of the lead regions 116 of the battery cells 110, which constitute the battery stack 100, provide (e.g., define) the overlap regions 118 and then are connected to the busbars 300. Therefore, the electrical connection between the lead regions 116 and the busbars 300 may be implemented without bending two opposite ends of the busbar 300 in the second direction D2 and then (e.g., tightly) attaching the lead regions 116 of the battery cells 110, which are disposed at two opposite ends in the second direction D2, to the two opposite bent ends of the busbar 300. According to the present disclosure, some of the other lead regions 116 of the plurality of battery cells 110, which may exclude the components for defining the overlap regions 118, may be (e.g., tightly) attached to the busbars 300 while spaced apart from the other lead regions in the first direction D1.

As illustrated in FIGS. 2 and 3, the battery module according to the present disclosure may further include first conductive sheets 400 provided to face the busbars 300 with the lead regions 116 interposed therebetween, the first conductive sheet 400 being (e.g., tightly) attached to the lead region 116 or the busbar 300. The first conductive sheet 400 may be configured to serve to receive thermal energy from the busbar 300 or the lead region 116 and discharge the thermal energy to the outside. Therefore, the first conductive sheet 400 may contain or be made of a thermally conductive material. As illustrated in FIGS. 2 and 3, the first conductive sheet 400 may be provided to cover and be (e.g., tightly) attached to the entire region in which the lead region 116 is (e.g., tightly) attached to the busbar 300.

As described above, according to the present disclosure, the busbar 300 may have a flat shape as a whole. For example, as illustrated in FIG. 3, according to the embodiment of the present disclosure, the regions of the busbars 300 to which the lead regions 116 are (e.g., tightly) attached may be provided on one imaginary plane P formed in a direction perpendicularly intersecting the second direction D2. For example, the (e.g., entire) outer surface of the busbar 300 in the second direction D2 may be provided on one imaginary plane P formed in the direction perpendicularly intersecting the second direction D2.

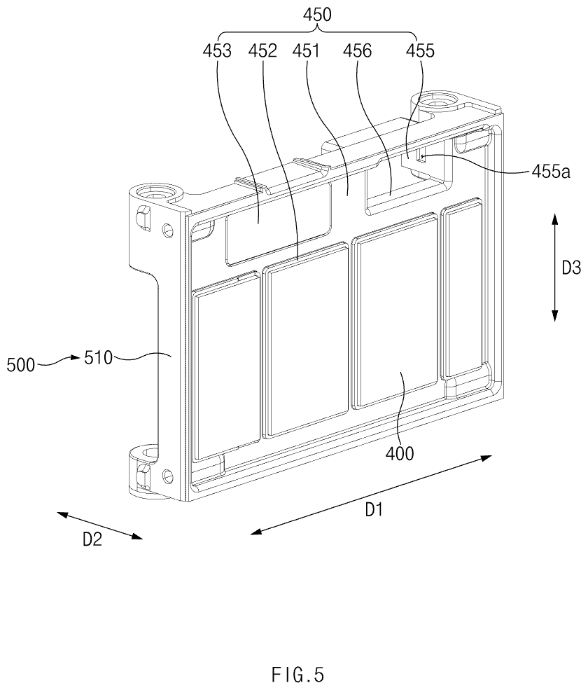

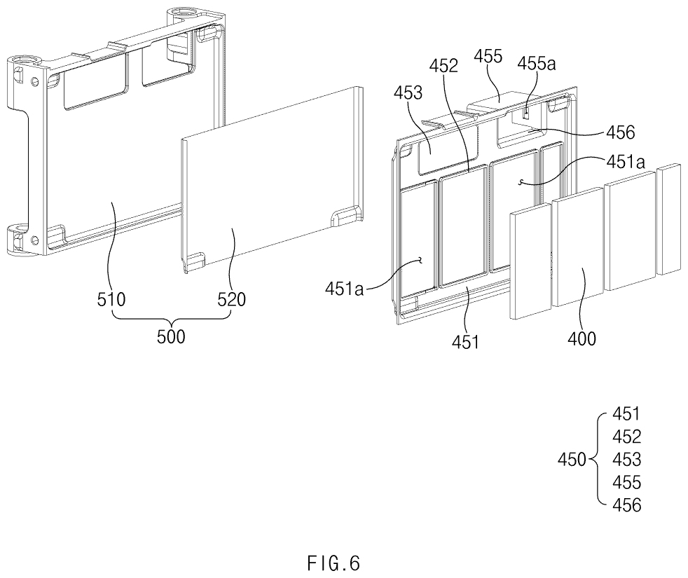

FIG. 5 is a perspective view illustrating a state in which an end cap member, an end cap spacing member, and the first conductive sheet provided in the battery module according to the present disclosure are assembled, and FIG. 6 is an exploded perspective view of FIG. 5.

With reference to FIGS. 1, 2, 5, and 6, the battery module 10 according to the present disclosure may further include an end cap spacing member 450 provided outward of the busbar 300 in the second direction D2 and having through-holes 451a configured to accommodate the first conductive sheets 400, and an end cap member 500 provided to face the busbars 300 with the end cap spacing member 450 and the first conductive sheets 400 interposed therebetween, the end cap member 500 being (e.g., tightly) attached to the first conductive sheets 400. Therefore, according to the present disclosure, the thermal energy transferred from the busbar 300 and the lead region 116 to the first conductive sheet 400 may be transferred back to the end cap member 500.

The end cap member 500 may be divided into a plurality of regions. For example, the end cap member 500 may include a cap body 510 configured to provide (e.g., define) a body of the end cap member 500 and containing an electrically conductive material, and an insulation sheet 520 provided between the cap body 510 and the first conductive sheet 400, (e.g., tightly) attached to the first conductive sheet 400, the cap body 510, and the end cap spacing member 450, and containing an electrically non-conductive material. With reference to FIGS. 5 and 6, the first conductive sheets 400 may be divided into a plurality of regions spaced apart from one another, and the through-holes 451a may also be divided into a plurality of regions spaced apart from one another while corresponding to the first conductive sheets 400.

An (e.g., entire) outer surface of the first conductive sheet 400 in the second direction D2 may be (e.g., tightly) attached to the insulation sheet 520. This may be to provide (e.g., ensure) the complete electrical insulation between the first conductive sheet 400 and the cap body 510. For example, as illustrated in FIGS. 5 and 6, an (e.g., entire) outer periphery of the first conductive sheet 400 may be spaced apart inward from an (e.g., entire) outer periphery of the insulation sheet 520.

In addition, as illustrated in FIGS. 1 and 2, the battery module 10 according to the present disclosure may further include second conductive sheets 550 (e.g., tightly) attached to one side surface of the cap body 510 and containing a thermally conductive material. The second conductive sheet 550 may be configured to receive thermal energy transferred to the end cap member 500 and discharge the thermal energy to the outside. For example, the second conductive sheet 550 may be (e.g., tightly) attached to one side surface of the cap body 510 in a third direction D3. As described below, a cooling pipe may be provided at one side of the battery module 10 in the third direction D3 and provide (e.g., define) a flow path through which a cooling fluid flows. The second conductive sheet 550 may be (e.g., tightly) attached to the cooling pipe.

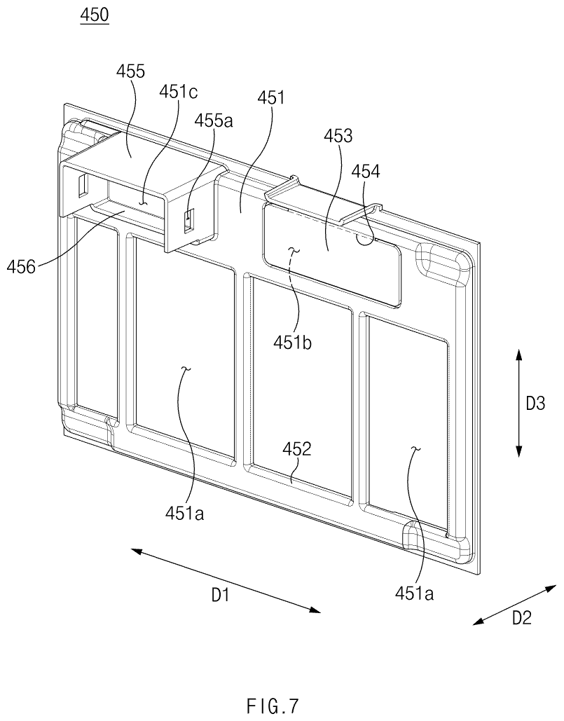

FIG. 7 is a perspective view of the end cap spacing member provided in the battery module according to the present disclosure.

With reference to FIGS. 5 to 7, the end cap spacing member 450 provided in the battery module 10 according to the present disclosure may be divided into a plurality of regions. For example, the end cap spacing member 450 may include a cap spacing body 451 configured to provide (e.g., define) a body of the end cap spacing member 450 and having the above-mentioned through-holes 451a, and cap spacing interference regions 452 protruding from the cap spacing body 451.

The cap spacing interference region 452 may be configured to provide (e.g., ensure) the electrical insulation between the end cap member 500 and the busbar 300 by providing (e.g., ensuring) a minimum spacing distance between the end cap member 500 and the busbar 300. Therefore, the cap spacing interference region 452 may be provided to face the busbar 300. That is, according to the present disclosure, minimum spacing may be provided (e.g., ensured) by a length of the cap spacing interference region 452 between the end cap member 500 and the busbar 300. For example, with reference to FIGS. 4, 6, and 7, the cap spacing interference region 452 may protrude from the cap spacing body 451 toward the busbar 300, and the cap spacing interference region 452 may be provided in a peripheral region that provides (e.g., defines) the through-hole 451a. For example, the cap spacing interference region 452 may protrude from the cap spacing body 451 in the third direction D3 intersecting the first and second directions D1 and D2. A length of the cap spacing interference region 452 in the third direction D3 may be equal to or larger than a thickness of the first conductive sheet 400 in the third direction D3.

The end cap spacing member 450 according to the present disclosure may further include other regions. For example, as illustrated in FIG. 7 and the like, the end cap spacing member 450 may include the cap spacing body 451 configured to provide (e.g., define) the body of the end cap spacing member 450 and having a discharge hole 451b spaced apart from the first conductive sheet 400, a cover region 453 accommodated in the discharge hole 451b, and a fracture region 454 configured to connect the cap spacing body 451 and the cover region 453.

The discharge hole 451b may be configured to provide a route through which a gas and a material, which are produced in the battery stack 100 when thermal runaway occurs in the battery stack 100 and pressure increases, are discharged to the outside. The cover region 453 may be configured to close the discharge hole 451b. Therefore, in case that thermal runaway occurs in the battery stack 100, the fracture region 454 may be fractured, and the cover region 453 may be spaced apart from the discharge hole 451b, such that the gas and the material may be discharged to the outside through the discharge hole 451b.

In order to exhibit the above-mentioned functions, the fracture region 454 may (e.g., needs to) be (e.g., quickly) fractured in comparison with the other regions of the end cap spacing member 450. Therefore, according to the present disclosure, i) a thickness of the fracture region 454 may be smaller than a thickness of the cap spacing body 451 and a thickness the cover region 453 in a region connected to the fracture region 454, or ii) the fracture region 454 may be provided (e.g., only) at a part of a periphery of the cover region 453. FIG. 7 illustrates a state in which the fracture region 454 is provided (e.g., only) at one side end in the third direction D3 of the peripheral region of the cover region 453.

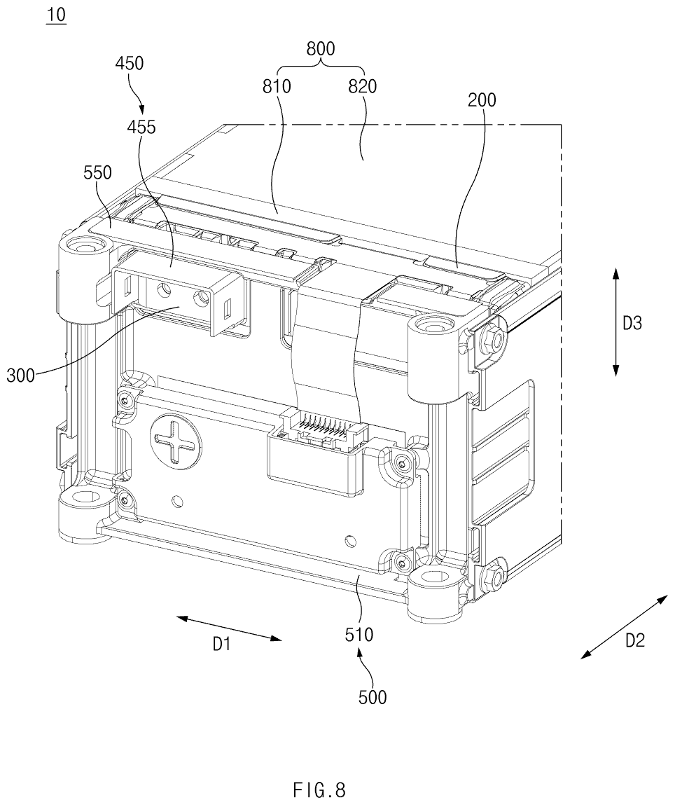

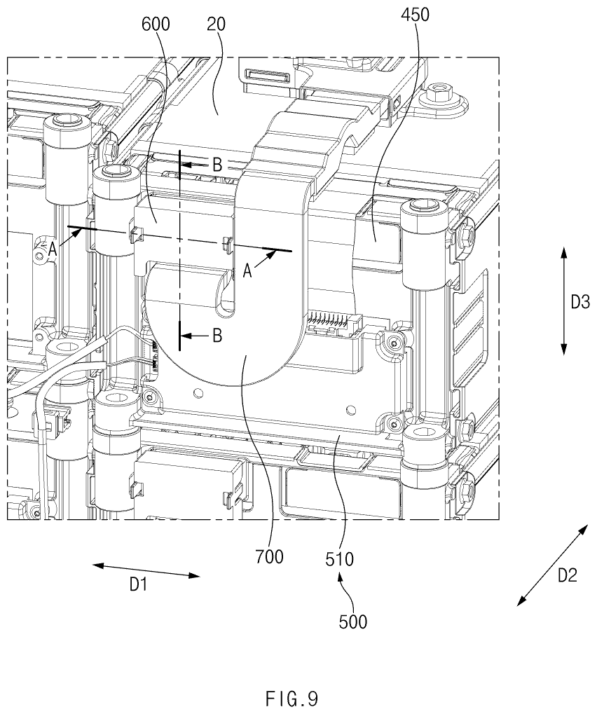

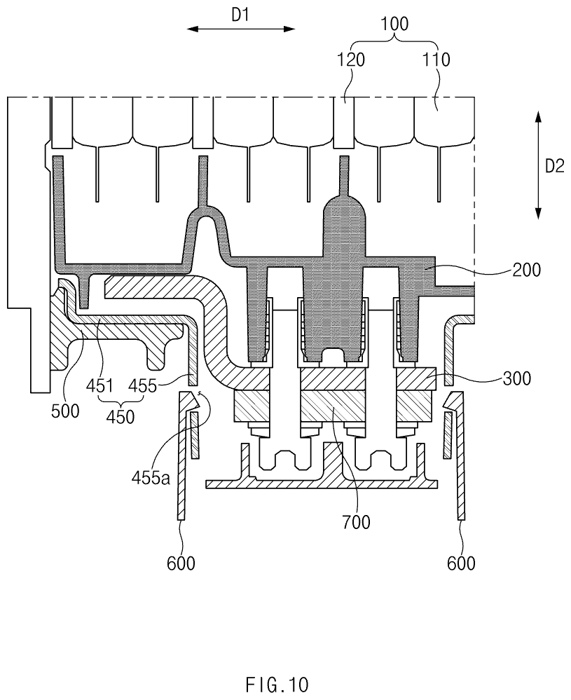

FIG. 8 is an enlarged view illustrating one side of the battery module in the second direction according to the present disclosure, and FIG. 9 is an enlarged view illustrating a state in which an outer busbar is assembled to the battery module according to the present disclosure. FIG. 10 is a view illustrating a cut surface taken along line A-A in FIG. 9.

With reference to FIGS. 7 to 10, the end cap spacing member 450 according to the present disclosure may include the above-mentioned cap spacing body 451, and a cap spacing protrusion region 455 provided on an outer surface of the cap spacing body 451 in the second direction D2 and protruding outward. In this case, a busbar accommodation hole 451c may be formed in a region of the cap spacing body 451 in which the cap spacing protrusion region 455 is provided. The busbar accommodation hole 451c may have a hole shape and may accommodate a partial region of the busbar 300. The cap spacing protrusion region 455 may have assembling holes 455a. In this case, the battery module 10 according to the present disclosure may further include a busbar protection cap member 600 configured to cover the busbar 300 from the outside and may have a partial region accommodated in the assembling hole 455a.

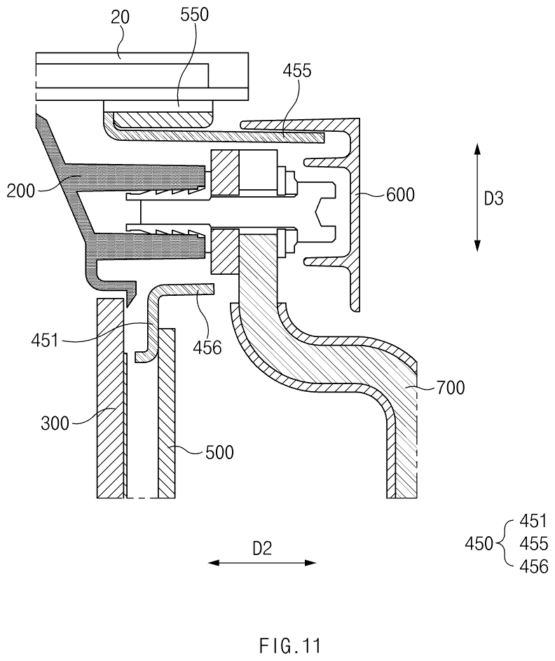

FIG. 11 is a view illustrating a cut surface taken along line B-B in FIG. 9.

In addition, as illustrated in FIGS. 8 to 11, the battery module 10 according to the present disclosure may further include an outer busbar 700 provided to be in contact with the busbar 300. In this case, the outer busbar 700 may be inserted into the busbar protection cap member 600 while penetrating the busbar protection cap member 600 and provided to be in contact with the busbar 300. The outer busbar 700 may be configured to electrically connect the two battery modules 10 adjacent to each other. For example, the two adjacent battery modules 10 may be electrically connected to each other by contact between the outer busbar 700 and the busbars 300 respectively provided in the two battery modules 10.

As illustrated in FIG. 11, the end cap spacing member 450 may further include a contact prevention region 456 protruding toward the outer busbar 700 and provided to face a region of the cap spacing body 451 in which the outer busbar 700 penetrates the busbar protection cap member 600. The contact prevention region 456 may be configured to provide (e.g., ensure) electrical connection between the end cap member 500 and the busbar 300 or between the end cap member 500 and the outer busbar 700 by providing (e.g., ensuring) minimum spacing between the end cap member 500 and the busbar 300 or between the end cap member 500 and the outer busbar 700.

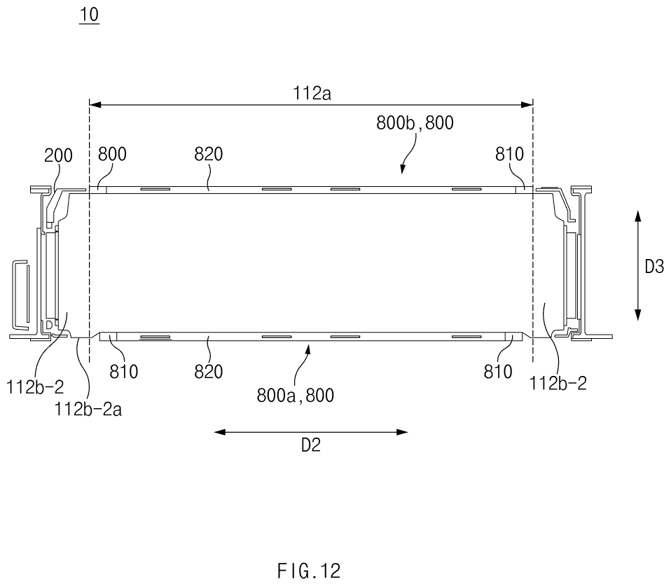

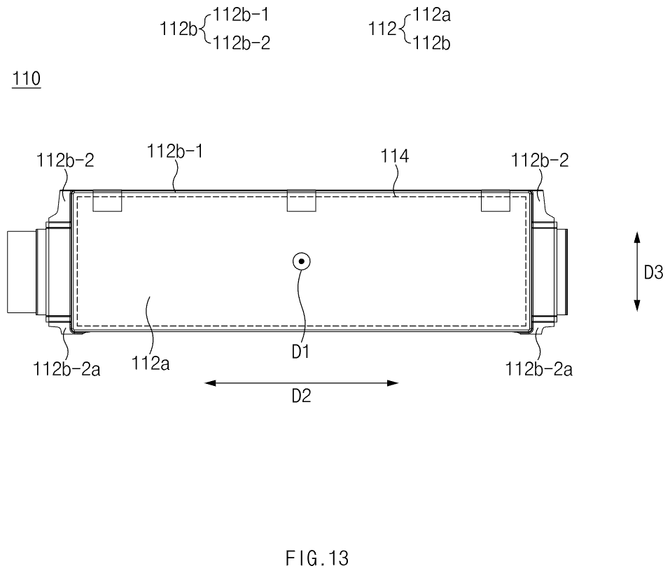

FIG. 12 is a cross-sectional view illustrating a state in which the battery module according to the present disclosure is cut in the direction perpendicular to the first direction, and FIG. 13 is a side view of the battery cell provided in the battery module according to the present disclosure.

With reference to FIGS. 12 and 13, the battery module 10 according to the present disclosure may further include heat transfer members 800 provided at one side of the battery stack 100 and provided to be in contact with the battery stack 100. The heat transfer member 800 may be configured to receive heat generated in the battery stack 100, particularly, the battery cell 110, and dissipate the heat to the outside. To this end, the heat transfer member 800 may contain or be made of a material with excellent thermal conductivity.

The plurality of battery cells 110 may each extend in the second direction D2. For example, the first direction D1 and the second direction D2 may be horizontal directions. In this case, the heat transfer member 800 may be provided at one side of the battery stack 100 in the third direction D3 intersecting the first and second directions D1 and D2. For example, the third direction D3 may be a vertical direction. For example, the first direction D1 may be a thickness direction of the battery cell 110, and the second and third directions D2 and D3 may be longitudinal directions in which the battery cell 110 extends. For example, the first direction D1, the second direction D2, and the third direction D3 may perpendicularly intersect one another.

The heat transfer members 800 according to the present disclosure may include a plurality of components made of different materials. For example, the heat transfer members 800 may include first and second heat transfer members 810 and 820 made of different materials.

The first and second heat transfer members 810 and 820 may each contain or be made of a curable material. Therefore, according to the present disclosure, the heat transfer member 800 may be formed by applying a material having fluidity onto one side of the battery stack 100 and then curing the material. In this case, according to the present disclosure, the fluidity of the first heat transfer member 810 measured before the first heat transfer member 810 is cured may be lower than the fluidity of the second heat transfer member 820 measured before the second heat transfer member 820 is cured.

According to the present disclosure, the first heat transfer member 810 may be configured to prevent the second heat transfer member 820 from spreading to an undesired region because of the fluidity of the second heat transfer member 820 during a process of curing the second heat transfer member 820 after the second heat transfer member 820 is applied. That is, the first heat transfer member 810 may serve to receive heat generated in the battery cell 110 and discharge the heat to the outside, and also serve to regulate a position to which the second heat transfer member 820 is applied.

In order to exhibit the above-mentioned functions, the first heat transfer members 810 may be applied in peripheral regions of the second heat transfer member 820. For example, the first heat transfer member 810 may be applied in the peripheral region at one side of the second heat transfer member 820 in the second direction D2. For example, FIG. 12 respectively illustrate states in which the first heat transfer members 810 are applied to the peripheral regions at one side and the other side of the second heat transfer member 820 in the second direction D2. This is a configuration in which the first heat transfer members 810 in the two regions may be provided to face each other with the second heat transfer member 820 interposed therebetween. In this case, it may be possible to prevent the second heat transfer member 820 from spreading in the second direction D2 during the process of applying and curing the second heat transfer member 820.

With reference to FIGS. 1 and 12, a maximum length of the first heat transfer member 810 in the first direction D1 may be shorter than a maximum length of the second heat transfer member 820 in the first direction D1. This is a configuration in which some of the materials of the second heat transfer member 820 partially spread in the first direction D1 during the process of applying and curing the second heat transfer member 820. However, even in this case, as described below, according to the present disclosure, the second heat transfer member 820 may be prevented from spreading to the (e.g., entire) region in the first direction D1.

In the battery module 10 according to the present disclosure, the heat transfer members 800 may be provided at two opposite sides of the battery stack 100 in the third direction D3. This is a configuration in which the heat transfer members are respectively provided in upper and lower regions of the battery module 10.

As illustrated in FIG. 13, the battery cells 110 provided in the battery module 10 according to the present disclosure may each include a pouch-type exterior material 112 having an internal space, and an electrode stack 114 accommodated in the internal space. Further, the pouch-type exterior material 112 may include a pouch body region 112a configured to provide (e.g., define) the internal space, and a sealing region 112b formed by attaching partial regions of the pouch-type exterior material 112 and provided to surround a periphery of the pouch body region 112a. In addition, the sealing region 112b may include a first sealing region 112b-1 formed at one side of the pouch-type exterior material 112 in the third direction D3. The first sealing region 112b-1 may be provided to be in contact with the heat transfer member 800.

The sealing region 112b may further include second sealing regions 112b-2 connected to one side end of the first sealing region 112b-1 in the second direction D2 and protruding in the second direction D2. The sealing region 112b may have an approximately “U” shape that surrounds the peripheral region of the pouch body region 112a. In this case, the second sealing regions 112b-2 may be respectively provided at two opposite side ends of the first sealing region 112b-1 in the second direction D2.

According to the present disclosure, bat ear sections 112b-2a may be provided at one side end of the second sealing region 112b-2 in a direction of the third direction D3 away from the first sealing region 112b-1, and the bat ear sections 112b-2a may protrude outward from the pouch body region 112a in the third direction D3. The bat ear section 112b-2a may be a region formed during a process of forming the pouch-type exterior material 112 having the internal space formed by joining partial regions of a pouch-type sheet. For example, the pouch-type exterior material 112 may be formed by forming a recessed region by forming the partial regions of the pouch-type sheet and then attaching peripheral regions of the recessed region. In this case, the bat ear section 112b-2a may be a section geometrically created because a thickness of the regions (i.e., the sealing regions) of the pouch-type exterior material 112, which are joined to each other, is relatively small, whereas a thickness of the region (i.e., the pouch body region) of the pouch-type exterior material 112, which provides (e.g., defines) the internal space, is relatively large.

According to the present disclosure, the heat transfer member 800 may be in contact with one side surface of the pouch body region 112a in the third direction D3 and may be provided inward of the bat ear sections 112b-2a in the second direction D2. This may prevent the bat ear section 112b-2a from being damaged by contact with the heat transfer member 800. For example, the heat transfer member 800 may be provided to overlap the bat ear sections 112b-2a in the third direction D3 and may be provided to be spaced apart inward from the bat ear sections 112b-2a in the second direction D2. The bat ear section 112b-2a may be disposed in a lower region of the battery cell 110 in FIG. 5. The heat transfer member 800, which overlaps the bat ear section 112b-2a in the third direction D3, may be a lower heat transfer member to be described below.

The battery module 10 according to the present disclosure may be one component provided in a battery pack. For example, the battery pack may include the battery module 10, and a cooling pipe 20 provided at one side of the battery module 10 in the third direction D3 and configured to provide (e.g., define) a flow path through which a cooling fluid flows. In this case, the second conductive sheet 550 may be (e.g., tightly) attached to the cooling pipe 20. Therefore, it is possible to (e.g., effectively) transfer thermal energy, which is transferred from the battery stack 100 to the first conductive sheet 400 and the second conductive sheet 550, to the cooling pipe 20.

The heat transfer members 800 provided on the battery module 10 according to the present disclosure may include a lower heat transfer member 800a provided in a lower region of the battery module 10 and provided between the battery stack 100 and the cooling pipe 20, and an upper heat transfer member 800b provided in an upper region of the battery module 10 and provided to face the lower heat transfer member 800a with the battery stack 100 interposed therebetween. The lower heat transfer member 800a and the upper heat transfer member 800b may respectively correspond to the heat transfer members 800 provided at the two opposite sides of the battery stack 100 in the third direction D3.

According to the present disclosure, the upper heat transfer member 800b may be fixedly coupled to the battery stack 100, and the lower heat transfer member 800a may be fixedly coupled to the cooling pipe 20. For example, according to the present disclosure, during a process of manufacturing the battery pack or the battery module, the lower heat transfer member 800a may be fixed to the cooling pipe 20 by i) applying or attaching the first heat transfer members 810 to the two opposite sides of the upper surface of the cooling pipe 20 in the second direction D2, ii) applying the second heat transfer member 820 to the internal space provided (e.g., defined) by the first heat transfer member 810, and then iii) curing the first heat transfer member 810 and the second heat transfer member 820. In addition, during the process of manufacturing a battery pack 1 according to the present disclosure, the upper heat transfer member 800b may be fixed to the battery stack 100 by i) applying or attaching the first heat transfer members 810 to the two opposite sides of the upper surface of the battery stack 100 in the second direction D2, ii) applying the second heat transfer member 820 to the internal space provided (e.g., defined) by the first heat transfer member 810, and then iii) curing the first heat transfer member 810 and the second heat transfer member 820. Therefore, in the battery pack 1 according to the present disclosure, the battery stack 100 and the lower heat transfer member 800a may be (e.g., tightly) attached to each other without being fixed to each other. Alternatively, the battery stack 100 and the lower heat transfer member 800a may be fixed to each other.

As described above, the lower heat transfer member 800a and the upper heat transfer member 800b may each include the first heat transfer member 810 and the second heat transfer member 820. In this case, as illustrated in FIG. 12, a width and a position in the first direction D1 and the second direction D2 of the first heat transfer member 810 of the upper heat transfer member 800b may correspond to a width and a position in the first direction D1 and the second direction D2 of the first heat transfer member 810 of the lower heat transfer member 800a, and a width and a position in the first direction D1 and the second direction D2 of the second heat transfer member 820 of the upper heat transfer member 800b may correspond to a width and a position in the first direction D1 and the second direction D2 of the second heat transfer member 820 of the lower heat transfer member 800a. This is a configuration in which the upper heat transfer member 800b and the lower heat transfer member 800a may have substantially the same size and shape, and also (e.g., entirely) overlap each other when the battery pack 1 is viewed from a location spaced apart from the battery pack 1 in the third direction D3.

The present disclosure has been described with reference to the limited embodiments and the drawings, but the present disclosure is not limited thereby. The present disclosure may be carried out in various forms within the technical spirit of the present disclosure and the appended claims.

What is claimed is:

1. A battery module comprising:
a battery stack including a plurality of battery cells stacked in a first direction, and at least one pad member provided between the plurality of battery cells;
a holder member provided at a side of the battery stack in a second direction, wherein the second direction intersects the first direction;
a busbar coupled to the holder member and electrically connected to the battery stack; and
a first conductive sheet provided to face the busbar, wherein the first conductive sheet contains a thermally conductive material,
wherein each battery cell of the plurality of battery cells has a lead region protruding outward and attached to the busbar, and
wherein the lead region is interposed between the first conductive sheet and the busbar, and the first conductive sheet is attached to the lead region or the busbar.

2. The battery module of claim 1, wherein an outer surface of the busbar in the second direction is provided on an imaginary plane formed in a direction intersecting the second direction.

3. The battery module of claim 2, wherein the first conductive sheet is configured to cover a region in which the lead region is attached to the busbar.

4. The battery module of claim 1, further including:
an end cap spacing member provided outward of the busbar in the second direction and having a through-hole configured to accommodate the first conductive sheet; and
an end cap member provided to face the busbar, the end cap spacing member interposed between the end cap member and the first conductive sheet, the end cap member attached to the first conductive sheet.

5. The battery module of claim 4, wherein the end cap member includes:
a cap body configured to provide a body of the end cap member, wherein the cap body contains an electrically conductive material; and
an insulation sheet provided between the cap body and the first conductive sheet, wherein the insulation sheet is attached to the first conductive sheet, the cap body, and the end cap spacing member, and wherein the insulation sheet contains an electrically non-conductive material.

6. The battery module of claim 5, further including:
a second conductive sheet attached to a side surface of the cap body and contains a thermally conductive material.

7. The battery module of claim 6, wherein the second conductive sheet is attached to the side surface of the cap body in a third direction, wherein the third direction intersects the first and second directions.

8. The battery module of claim 5, wherein an outer surface of the first conductive sheet in the second direction is attached to the insulation sheet.

9. The battery module of claim 8, wherein an outer periphery of the first conductive sheet is spaced apart and inward from an outer periphery of the insulation sheet.

10. The battery module of claim 4, wherein the end cap spacing member includes:
a cap spacing body configured to provide a body of the end cap spacing member and having the through-hole; and
a cap spacing interference region protruding from the cap spacing body and
wherein the cap spacing interference region is provided to face the busbar.

11. The battery module of claim 10, wherein the cap spacing interference region protrudes from the cap spacing body toward the busbar.

12. The battery module of claim 10, wherein the cap spacing interference region is provided in a peripheral region that provides the through-hole.

13. The battery module of claim 10, wherein the cap spacing interference region protrudes from the cap spacing body in a third direction, the third direction intersecting the first and second directions, and a length of the cap spacing interference region in the third direction is substantially equal to or larger than a thickness of the first conductive sheet in the third direction.

14. The battery module of claim 4, wherein the end cap spacing member includes:
a cap spacing body configured to provide a body of the end cap spacing member and having a discharge hole spaced apart from the first conductive sheet;
a cover region accommodated in the discharge hole; and
a fracture region configured to connect the cap spacing body and the cover region, and
wherein
i) a thickness of the fracture region is smaller than a thickness of the cap spacing body and a thickness of the cover region in a region connected to the fracture region, or
ii) the fracture region is provided at a part of a periphery of the cover region.

15. The battery module of claim 4, wherein the end cap spacing member includes:
a cap spacing body configured to provide a body of the end cap spacing member; and
a cap spacing protrusion region provided on an outer surface of the cap spacing body in the second direction and protruding outward,
wherein a busbar accommodation hole, which has a hole shape and accommodates a partial region of the busbar, is formed in a region of the cap spacing body in which the cap spacing protrusion region is provided,
wherein the cap spacing protrusion region has an assembling hole, and
wherein the battery module further includes a busbar protection cap member configured to cover the busbar and has a partial region accommodated in the assembling hole.

16. The battery module of claim 15, further including:
an outer busbar provided to be in contact with the busbar,
wherein the outer busbar is inserted into the busbar protection cap member while penetrating the busbar protection cap member and is provided to be in contact with the busbar, and
wherein the end cap spacing member further includes a contact prevention region protruding toward the outer busbar and is provided to face a region of the cap spacing body in which the outer busbar penetrates the busbar protection cap member.

17. The battery module of claim 1, further including:
a heat transfer member provided at a side of the battery stack and is provided to be in contact with the battery stack,
wherein the plurality of battery cells extend in the second direction,
wherein the heat transfer member is provided in a third direction, the third direction intersecting the first and second directions and, and
wherein the heat transfer member includes a first heat transfer member and a second heat transfer member made of a different material than the first heat transfer member.

18. The battery module of claim 17, wherein the first heat transfer member and the second heat transfer member each contain a curable material, and fluidity of the first heat transfer member measured before curing the first heat transfer member is lower than fluidity of the second heat transfer member measured before curing the second heat transfer member.

19. The battery module of claim 17, wherein the first heat transfer member is applied to a peripheral region at a side of the second heat transfer member in the second direction.

20. The battery module of claim 17, wherein each battery cell of the plurality of battery cells includes:
a pouch-type exterior material having an internal space; and
an electrode stack accommodated in the internal space,
wherein the pouch-type exterior material includes
a pouch body region configured to provide the internal space, and
a sealing region formed by attaching partial regions of the pouch-type exterior material and provided to surround a periphery of the pouch body region,
wherein the sealing region includes a first sealing region formed at a side of the pouch-type exterior material in the third direction and
wherein the first sealing region is provided to be in contact with the heat transfer member.
